(19) United States
(12) Patent Application Publication
(10) Pub. No.: US 2021/0284425 A1
(43) Pub. Date: Sep. 16, 2021

(54) MODULAR COOLER SYSTEM AND METHOD OF MANUFACTURE

(71) Applicant: Douglas Stein, Wilmington, NC (US)

(72) Inventor: Douglas Stein, Wilmington, NC (US)

(21) Appl. No.: 16/815,145

(22) Filed: Mar. 11, 2020

(51) Int. Cl. B65D 81/38; G06F 1/16; H02J 7/02; H02J 7/00; H02J 7/35; H04R 1/02; G06F 3/16; H04R 1/08; A47J 43/27

(52) U.S. Cl. CPC B65D 81/3813; G06F 1/1632; H02J 7/02; H02J 7/0045; A47J 43/27; H04R 1/028; G06F 3/165; H04R 1/08; H02J 7/35

(57) ABSTRACT

An apparatus includes a cooler system having fun and practical conveniences that include a wireless charging area, a karaoke module, as well as a drink blender and a stainless steel bottle. The cooler system is compactly designed to accommodate the different modules and to supply power from one or more battery sources. A method of manufacturing the cooler system is also disclosed.

The present invention relates generally to portable coolers.

### BACKGROUND

People historically flock to beaches and parks for recreation. The park and beachgoers naturally desired to avail themselves of modern conveniences, such as cool drinks, cellular telephones, and audio equipment. Transporting all such conveniences may be burdensome and impractical due to their bulk, weight, or a lack of electricity.

### SUMMARY

According to one embodiment of the present invention, an apparatus includes a cooler system may having a wireless charging area, a karaoke module, as well as a drink blender and a stainless steel bottle. The cooler system is compactly designed to accommodate the different modules and to supply power from one or more battery sources.

According to another particular embodiment, a method of manufacture includes constructing a cooler module that includes a wireless charging area, a karaoke module, as well as a drink blender and a stainless steel bottle. The cooler system is compactly designed to accommodate the different modules and to supply power from one or more battery sources.

### BRIEF DESCRIPTION OF THE SEVERAL VIEWS OF THE DRAWINGS

FIG. 1 is a block diagram of a cooler system that is consistent with an embodiment of the invention;

FIG. 2 shows front view of an embodiment of the system that includes convenient storage, cup holders, and extra-wide soft-ride support wheel system;

FIG. 3 shows a perspective view of the system of FIG. 2;

FIG. 4 is a front view of another embodiment of a system that may include a wireless speaker system and a rechargeable built-in battery;

FIG. 5 shows a perspective view of the system of FIG. 4;

FIG. 6 is a front view of an embodiment of a system that may include a speaker with wireless Bluetooth capability and a long lasting battery, including a power bank and a USB charger, as well as a docking system;

FIG. 7 shows a perspective view of the system of FIG. 6; and

FIG. 8 is a flowchart of an embodiment of a method of manufacturing a cooler having multiple modular components.

### DETAILED DESCRIPTION

An embodiment of a cooler system may include fun and practical conveniences to include a wireless charging area, a karaoke module, as well as a drink blender and a stainless steel bottle. The cooler system is compactly designed to accommodate the different modules and to supply power from one or more battery sources.

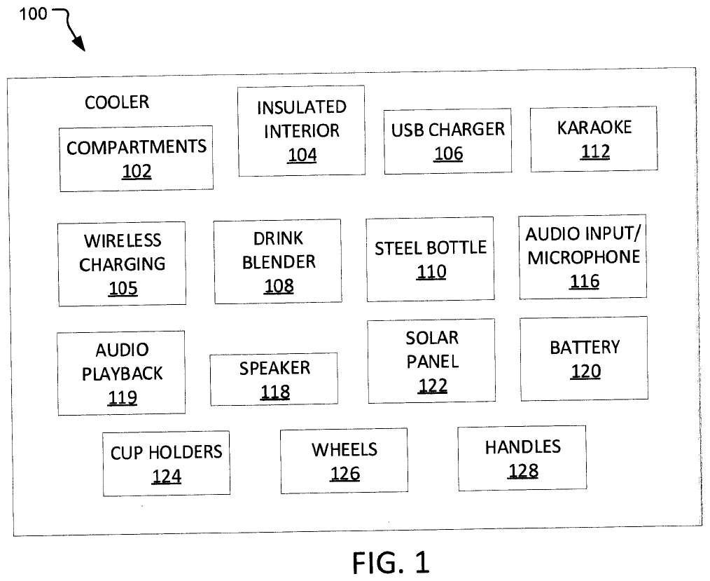

Turning more particularly to the Drawings, an embodiment of FIG. 1 is a block diagram of an embodiment of a system 100 that includes a cooler having waterproof safety compartments 102 and an insulated interior section 104. As explained here in, other modules of the system 100 may be waterproof or water-resistant. The system 100 may include a wireless charging area 105, as well as a Universal Serial Bus (USB) charger 106.

Despite the relatively compact nature of the cooler, the system 100 may include an attached drink blender 108 and a stainless steel bottle or other removably attached cup 110. In certain embodiments, the drink blender 108 may attach to an outside (e.g., top) surface of the cooler system 100, or it may be inserted inside a space designated within the system 100. An embodiment of the blender module 108 may be stored within a compartment within the system when not in use, as with the stainless steel bottle 110.

An embodiment of the system 100 may additionally include an attached karaoke system 112, including a microphone 116 (or microphone jack), as well as a speaker 118. An audio playback system 119 may also be included and wired to the speaker 118

To supply power to the various modules, the system 100 may include a battery 120 having connections throughout the system 100 to distribute power. The battery 120 and electrical system may be wired as to be water proof. Embodiment of the system may additionally include a solar panel 122 that is configured to recharge the battery 120. The battery 120 may also include an outlet for recharging. An algorithm may distribute power from the battery 120 according to present and sensed current needs of the varying modules.

As shown in FIG. 1, the cooler system 100 may also include cup holders 124, wheels 126, and a handle 128. Care may be taken to ensure waterproofing of the modules, both externally and internally.

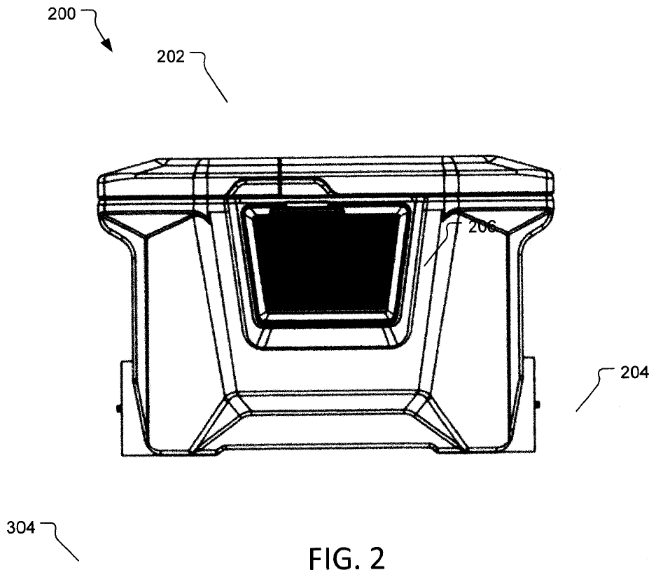

FIG. 2 shows front view of an embodiment of the system 200. The embodiment of the system 200 may include convenient storage, cup holders, and extra-wide soft-ride support wheel system. The materials may be made from plastic, metal, or foam. The size of an embodiment of an illustrative storage area may include 26″ by 16″ by 19″. The system 200 may weigh approximately 11 lbs. One skilled in the art will appreciate that the sizes may be altered in different embodiments. The system may include a distinctive front speaker system 206.

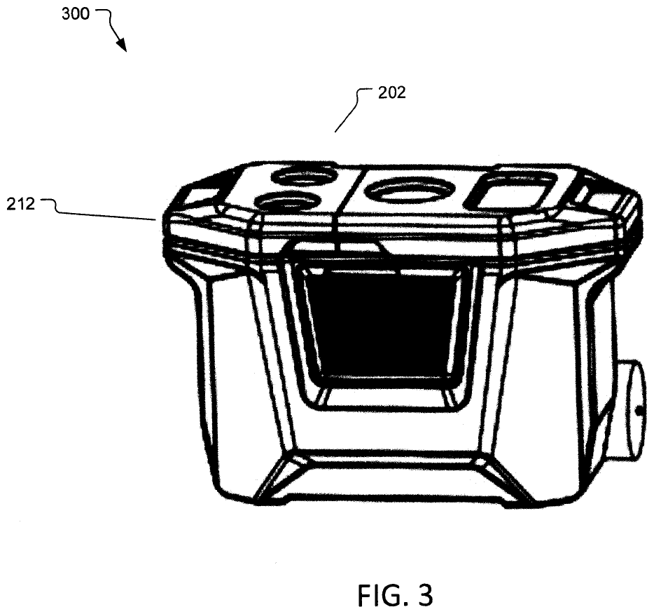

FIG. 3 shows a perspective view of the system of FIG. 2.

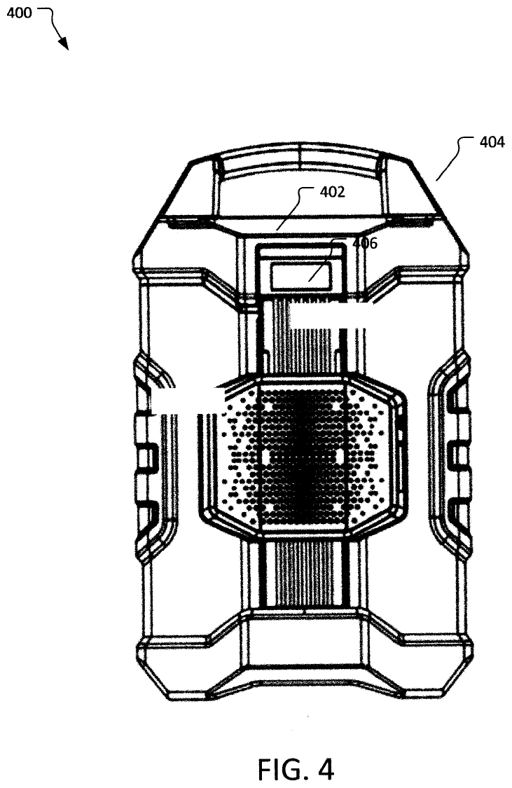

FIG. 4 is a perspective view of another embodiment of a system 400 that may include a wireless speaker system and a rechargeable built-in battery. The system 400 may include a docking station 402, as well as a comfortable handle 404. The wireless speaker may be waterproof.

Construction material may include plastic or other suitable lightweight material. A speaker may include Bluetooth capabilities and the battery may produce 800 milliamps per hour. The dimensions of the system may include 10″ by 10″ by 13″. Other embodiments may be larger or smaller. An embodiment of the system may weigh under 10 lbs. As shown in the drawing, the system may include controls 406 for the wireless speaker.

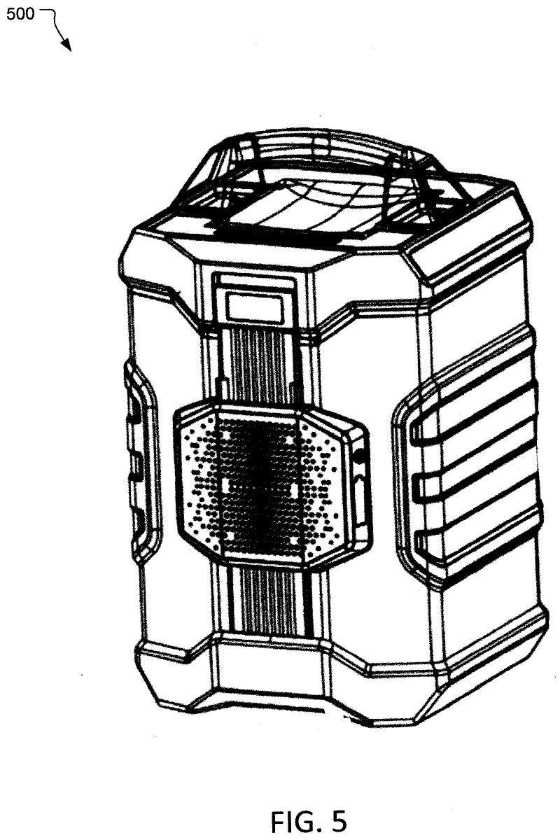

FIG. 5 shows a perspective view of the cooler system 400 of FIG. 4.

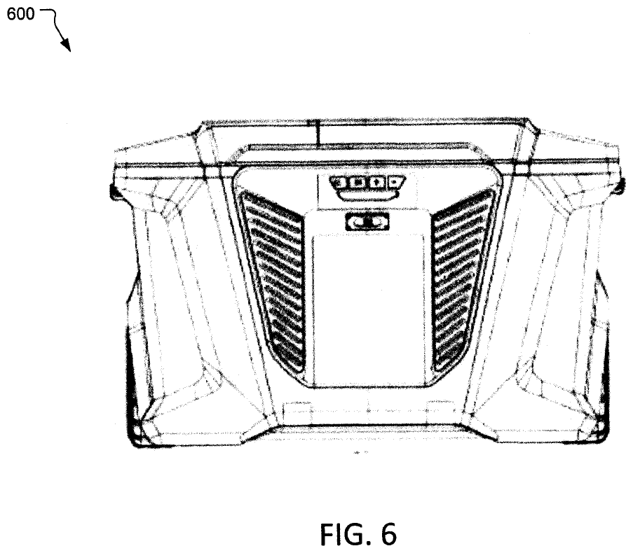

FIG. 6 is front view of another embodiment of the system 600 that may include a speaker with wireless Bluetooth capability and a long lasting battery, including a power bank and a USB charger. The battery may be rechargeable and the system maybe wireless and water resistant. The cooler system may also feature a bottle opener as well as a docking system and cup holders. The system may include oversized wheels and soft ride off-road wheel material.

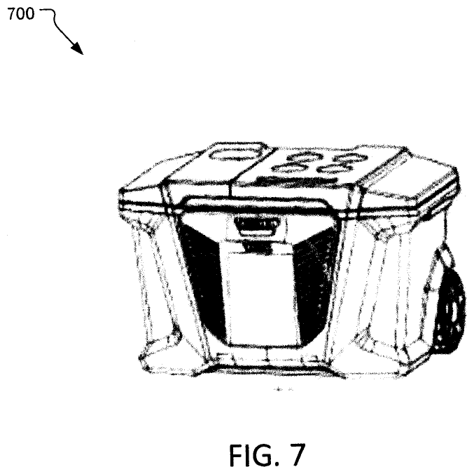

FIG. 7 is a perspective view of the cooler system 600 of FIG. 6.

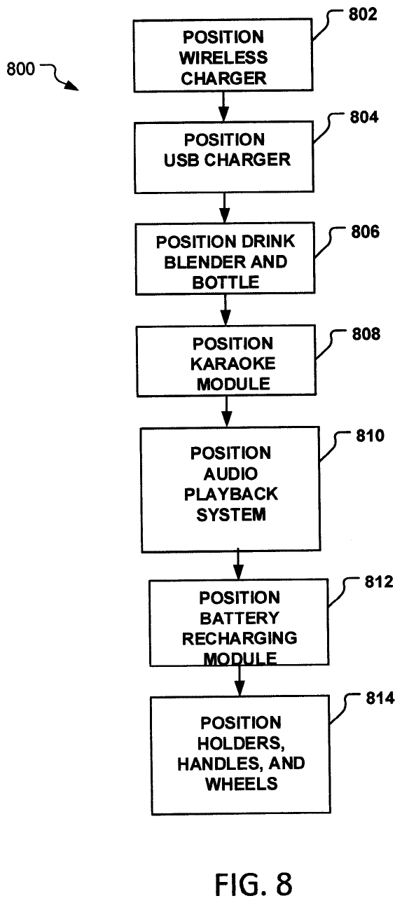

FIG. 8 is a flowchart of an embodiment of a method 800 of manufacturing a cooler having multiple modular components. For instance, such components may include the waterproof safety compartments 102 and an insulated interior section 104 of FIG. 1. At 802 and 804, the method 800 may include attaching a wireless charging area and a USB charger.

A drink blender and a stainless steel bottle may be positioned, removably attached, and otherwise included at 806. For example, the drink blender 108 and a stainless steel bottle 110 of FIG. 1 may be integrated into the module cooler.

An embodiment of the method may include at 808 attaching a karaoke system. The karaoke system may include a microphone, microphone jack, and a speaker. The speaker may also be utilized in an audio playback system that is attached at 810.

At 812, a battery having connections throughout the system to distribute power may be positioned, along with a recharging module. Cup holders, a handle, and wheels may be attached at 114.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the present invention are described herein with reference to flowchart illustrations and/or block diagraths of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. An apparatus comprising:
a cooler structure and internal compartment;
at least one of a handle and a wheel;
at least two of a docking station; a karaoke module, and a drink blender; and
a battery source powering the at least two of the docking station; a karaoke module, and a drink blender.

2. The apparatus of claim 1, further comprising a battery recharging module.

3. The apparatus of claim 1, further comprising a solar module.

4. The apparatus of claim 1, further comprising a speaker.

5. The apparatus of claim 1, further comprising an audio playback system.

6. The apparatus of claim 1, further comprising a microphone.

7. The apparatus of claim 1, further comprising a water-tight compartment.

8. A method of manufacturing a portable cooler, the method comprising:
providing a cooler structure and internal compartment;
providing at least one of a handle and a wheel;
providing at least two of a docking station; a karaoke module, and a drink blender; and
providing a battery source powering the at least two of the docking station; a karaoke module, and a drink blender.
